(19) United States
(12) Patent Application Publication
(10) Pub. No.: US 2025/0183530 A1
(43) Pub. Date: Jun. 5, 2025

(54) BEAMFORMING ANTENNA ARRAYS

(71) Applicant: Microsoft Technology Licensing, LLC, Redmond, WA (US)

(72) Inventors: Chulmin HAN, Redmond, WA (US); Apoorva SHARMA, Sammamish, WA (US); Marc HARPER, Snohomish, WA (US)

(21) Appl. No.: 18/527,689

(22) Filed: Dec. 4, 2023

(51) Int. Cl. H01Q 3/34; H01Q 21/06

(52) U.S. Cl. CPC H01Q 3/34; H01Q 21/065

(57) ABSTRACT

During signal reception, a tracking device includes a first antenna array configured to adjust a first steering angle of the first antenna array in a first plane and a second antenna array configured to adjust a second steering angle of the second antenna array in a second plane. The tracking device includes a phase difference of arrival calculator to determine a first phase shift between the first antenna array and the target device, a second phase shift between the second antenna array and the target device, and a phase difference of arrival between the first phase shift and the second phase shift. The tracking device includes a target device tracking circuit to determine the angle of arrival of the radiofrequency signal at the receiving device based on the phase difference of arrival.

### BACKGROUND

Ultra-wideband (UWB) refers to a radio technology that can use a very low energy level for short-range, high-bandwidth communications over a large portion of the radio spectrum. UWB can be used in many different applications including, without limitation, non-cooperative radar imaging, target sensor data collection, and precise locating and tracking. For example, a smart mobile phone may use UWB technology to locate a target device, such as a smart tracking tag. In most applications, UWB technology transmits data with short nanosecond pulses from the target device (e.g., a device to be tracked) over an “ultra-wide” range of frequencies. A tracking device can receive these signals and determine the location of a target device with respect to the tracking device.

As part of such tracking, such applications can employ a technology known as “angle of arrival” or AoA to determine the direction of radio-frequency wave propagation (e.g., from a target) incident at a tracking device. The AoA can be calculated by measuring the time difference of arrival (TDOA) between individual elements of the array. Generally, this TDOA measurement is made by measuring the difference in the received signal phases (the phase difference of arrival or PDoA) at each antenna in the antenna array. AoA measurements can be thought of as beamforming in reverse. In beamforming, the signal from each element is weighed to “steer” the gain of the antenna array. In AoA, the delay of arrival at each antenna in the tracking device is measured directly and converted to an AoA measurement. From the AoA, the direction of the target device from the tracking device may be determined. Combining AoA measurements with a distance measurement, such as by using received signal strength (RSS) or time of arrival (TOA) measurements, the tracking device can determine the location of the target device.

### SUMMARY

In some aspects, the techniques described herein relate to a receiving device for determining an angle of arrival of a radiofrequency signal received at the receiving device and transmitted by a target device, the receiving device including: a first antenna array configured to adjust a first steering angle of the first antenna array in a first plane; a second antenna array configured to adjust a second steering angle of the second antenna array in a second plane; a phase difference of arrival calculator communicatively coupled to the first antenna array and the second antenna array and configured to determine a first phase shift between the first antenna array and the target device, a second phase shift between the second antenna array and the target device, and a phase difference of arrival between the first phase shift and the second phase shift; and a target device tracking circuit electrically coupled to the phase difference of arrival calculator and configured to determine the angle of arrival of the radiofrequency signal at the receiving device based on the phase difference of arrival between the first phase shift and the second phase shift.

In some aspects, the techniques described herein relate to a method of determining an angle of arrival of a radiofrequency signal received at a receiving device and transmitted by a target device, the method including: adjusting a first steering angle of a first antenna array in a first plane; adjusting a second steering angle of a second antenna array in a second plane; determining a first phase shift between the first antenna array and the target device, a second phase shift between the second antenna array and the target device, and a phase difference of arrival between the first phase shift and the second phase shift; and determining the angle of arrival of the radiofrequency signal at the receiving device based on the phase difference of arrival between the first phase shift and the second phase shift.

In some aspects, the techniques described herein relate to a receiving device for determining an angle of arrival of a radiofrequency signal received at the receiving device and transmitted by a target device, the receiving device including: a first antenna array configured to adjust a first steering angle of the first antenna array in a first plane; a second antenna array configured to adjust a second steering angle of the second antenna array in a second plane; a phase difference of arrival calculator communicatively coupled to the first antenna array and the second antenna array and configured to determine a phase difference of arrival of beams of the radiofrequency signal received that the receiving device; and a target device tracking circuit electrically coupled to the phase difference of arrival calculator and configured to determine the angle of arrival of the radiofrequency signal at the receiving device based on the phase difference of arrival.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system including a mobile phone (a tracking device) and a tracking tag (a target device), wherein the system accommodates mobile phone tilt by adjusting steering angles of antenna arrays.

FIG. 2 illustrates an example system including a mobile phone (a tracking device) and a tracking tag (a target device), wherein the system scans antenna array steering angles to find the strongest received signal strength from the tracking tag.

FIG. 3 illustrates an example antenna array including a first antenna pair (e.g., forming an antenna array) and a second antenna pair (e.g., forming an antenna array) of a receiving device, both oriented to adjust steering angles in horizontal planes that are substantially parallel to each other.

FIG. 4 illustrates an example antenna array including a first antenna pair (e.g., forming an antenna array) and a second antenna pair (e.g., forming an antenna array) of a receiving device, both oriented to adjust and/or scan in vertical planes that are substantially parallel to each other.

FIG. 5 illustrates example circuitry for locating a target device (not shown).

FIG. 6 illustrates example circuitry for locating a target device (not shown).

FIG. 7 illustrates example geometric parameters for a receiver device's antenna array useful in locating a target device.

FIG. 8 illustrates example operations for determining an angle of arrival of a radiofrequency beam received at a receiving device and transmitted by a target device.

FIG. 9 illustrates an example computing device for use in implementing the described technology.

### DETAILED DESCRIPTIONS

Beamforming refers to a signal processing technique used in antenna arrays for directional signal transmission and reception. In some reception implementations, for example, beamforming is achieved by combining antenna elements in an antenna array in such a way that radiofrequency (RF) signals received at particular angles experience constructive interference, while RF signals received at other angles experience destructive interference. Beamforming can be used at both transmitting and receiving ends to achieve spatial selectivity, which allows directional transmission and reception. For the purpose of this description, a tracking device is referred to as an observer or an origin and employs beam forming for reception. A target device being tracked is referred to as a point of interest.

In one example scenario of the described technology, a target device transmits UWB signals that can be received by an antenna array of a tracking device. The tracking device can determine the angles of incidence of the UWB signals transmitted from a target device using beam forming at multiple antennas (while receiving) to measure the PDoA of the received signals and then determine the location of the target device based on the angles of incidence.

A fixed beam pattern antenna array of a tracking device, however, only allows accurate measurement of the PDoA of a received signal within a narrow angular range from a fixed axis of the antenna array. The accuracy of a PDoA measurement of an individual beam pattern received at two different antennas of an antenna array tends to deteriorate as the tracking device is tilted beyond a certain angle with respect to a reference (e.g., gravitational pull, the Earth's magnetic field (e.g., magnetic North), an estimated direction of the target device transmitting a UWB signal to allow for locating and tracking). For example, a fixed beam pattern may extend on a fixed axis that is orthogonal from a display of a mobile phone. As the orientation of the target device deviates from this fixed orthogonal axis (e.g., as the tracking device is tilted away from the target device), the PDoA becomes less accurate because the results are no longer stable, monotonic, or reproducible.

In some implementations, when the angles between the tracking device axis and the angle of the target device begin to deviate, the electric field vector's orientation of the received signal changes. The misalignment in polarization can, therefore, cause the received signal's electric field to be decomposed into two components: one that aligns with the antenna's polarization and another that is orthogonal to it. These components can experience different phase shifts, potentially affecting the overall phase of the received signal and increasing the ambiguity of AoA.

Moreover, the polarization mismatch can also reduce the received signal's strength, resulting in a lower signal-to-noise ratio and impairing the accuracy of the AoA estimation. In other words, the received signal may be too weak to be detected above ambient RF noise, which makes it difficult to estimate the AoA accurately.

In addition, in multipath environments, the received signal is the sum of multipath signals. At low SNR levels, it can be difficult to separate the direct signal from reflected signals, which can also cause errors in AoA estimation.

These inaccuracies apply to any single fixed beam pattern, regardless of the fixed angle (e.g., orthogonal to the display or not). Mathematically, the axis of the tracking device's antenna array beam pattern is referred to as an azimuth, a relative position vector from an observer (origin) to a point of interest (target) onto a reference plane. Accordingly, a three-dimensional location of a target with respect to an observer may be obtained by using two or more observers oriented in different planes.

Even combining multiple fixed-axis antenna arrays (operating at differently angled axes) in a locating device, for example, does not provide acceptable performance. Angular regions between the differently angled fixed axes still result in the same type of deterioration at the extremes of each array's angular range, particularly at greater distances between the tracking device and the target device. Furthermore, the number of antennas in the array increases with each fixed axis beam pattern added to the device, even as available device real estate is at a premium and is growing less available each year.

As applied to the described technology, a phased array receiver in a tracking device includes an array of antennas (an antenna array) that uses phase shifters to adjust the phase of the radio waves received by each antenna element, thereby adjusting the axis of the tracking device's antenna array beam pattern. The phased array receiver combines (in a combiner) the received radio waves so that radio waves received from a defined angle of incidence are output from the combiner are significantly stronger than radio waves received at other angles. Moreover, the phase shifters can be dynamically adjusted in time to sweep or scan across a range of angles in a plane. In this way, the phased array receiver can scan to identify an angle of incidence at which the UWB signal is received from a target device (e.g., the angle corresponding with the strongest received signal at the combiner). The defined angle of incidence is also referred to as a “steering angle” (even at a receiver).

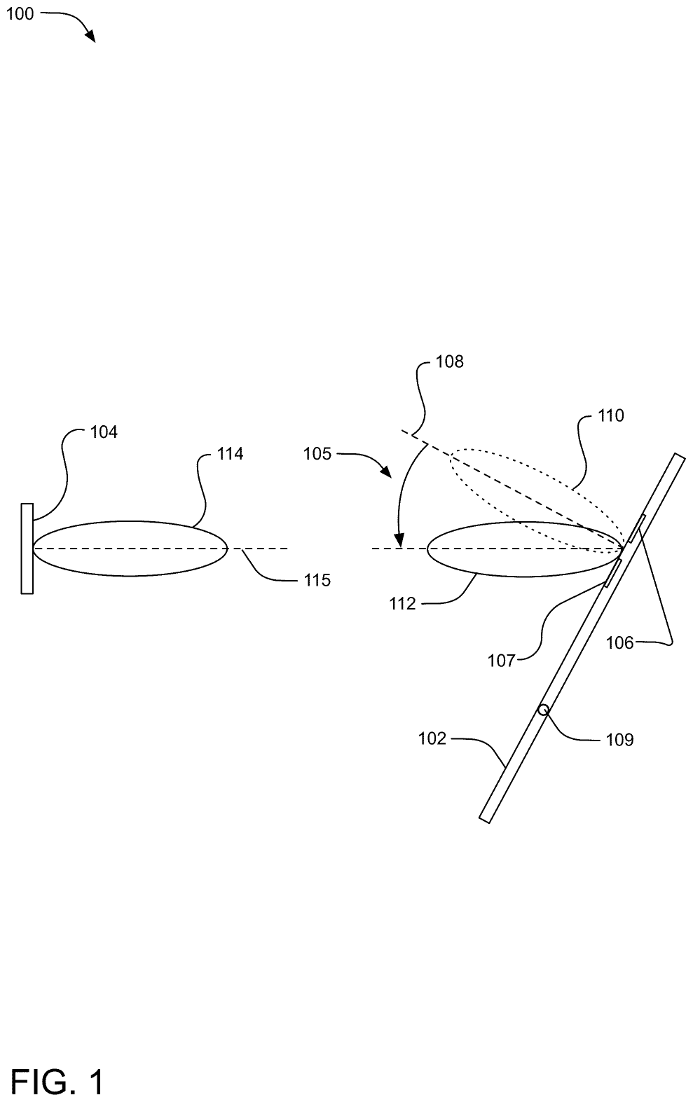

FIG. 1 illustrates an example system 100 including a mobile phone 102 (a tracking device) and a tracking tag 104 (a target device), wherein the system 100 accommodates mobile phone tilt by adjusting steering angles of antenna arrays. The mobile phone 102 includes an antenna array (represented by an antenna 106 and an antenna 107) that is used to detect and locate the tracking tag 104, which transmits tracking signals (e.g., UWB signals) at regular intervals. In the described technology, two (e.g., substantially parallel) antenna arrays are used in combination to determine the AoA of the signals received from the tracking tag 104. Furthermore, the same (or other) antennas may be used in antenna arrays having different orientations (e.g., horizontal as opposed to vertical) to the antenna arrays shown to improve three-dimensional AoA detection.

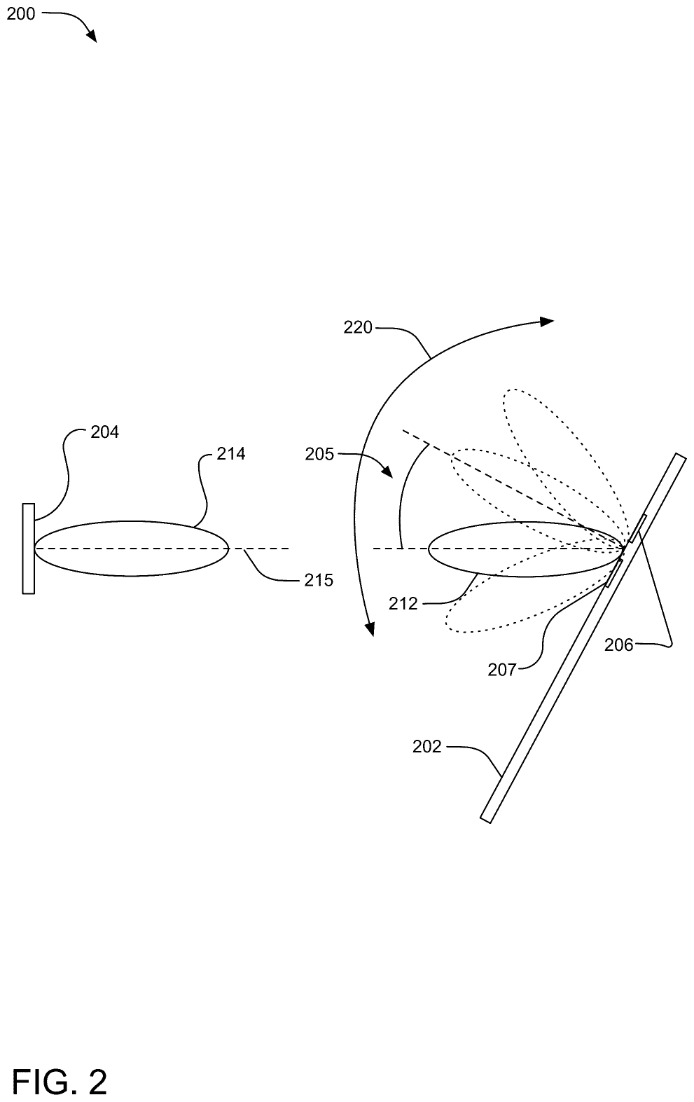

In one implementation, the receive steering angles of the antenna arrays are adjusted to offset a detected tilt in the mobile phone 102 with respect to the tracking tag 104 signal transmission. For example, various sensors can be used to detect tilt, including, without limitation, accelerometers, gyroscopes, compasses, GPS sensors, and time-of-flight sensors. An example tilt sensor 109 is shown in FIG. 1. In another implementation, the antenna arrays can scan across a defined angular range to find a phase (e.g., which translates to angle) at which the received signal strength is strongest (see, e.g., FIG. 2). In some implementations, the antenna arrays are oriented to adjust the receive steering angles across a defined angular range in substantially parallel planes (e.g., horizontal planes, vertical planes). Furthermore, in some implementations, the scanning aspect can be used with PDoA calculations to determine AoA in multiple dimensions (e.g., vertical and horizontal), such that the scanning determines the AoA in one dimension, and then the PDoA between the two antenna arrays can be used to determine the AoA in the other dimension.

In the described technology, rather than extending a beam pattern on a fixed axis, the antenna array can adjust a beam pattern in a first plane across a wide angular range with respect to the mobile phone 102. As shown, the mobile phone 102 is tilted with respect to the transmission beam axis of the tracking tag 104 (see, e.g., tilt angle 105). The dashed line 108 indicates an orthogonal axis from the mobile phone 102, and the dashed oval 110 indicates a main lobe or main beam of an antenna array along the orthogonal axis. The main lobe or main beam is the region of the radiation pattern containing the highest power or exhibiting the greatest field strength. Because the mobile phone 102 is tilted, the angle of the main lobe along this orthogonal axis is likely to result in inaccurate AoA results.

As such, phase shifters adjust the phase of the signal sent to the antenna array to adjust the angle of the main lobe. In the implementation shown in FIG. 1, the adjustment angle offsets the tilt angle 105 so that the main lobe (as shown by the solid oval 112) is directed toward the tracking tag 104. The main lobe of the tracking tag transmissions is shown as solid oval 114 along an axis 115. This approach is intended to maximize or increase the received signal strength as compared to other angles. Accordingly, the phase shifters of the antenna arrays in the mobile phone 102 dynamically adjust the phases of antennas so as to adjust the steering angle of the main lobe of each antenna array on reception. In the implementation of the described technology shown in FIG. 1, two antenna arrays make similar adjustments to their steering angles in substantially parallel first planes in order to offset the tilt angle 105 of the mobile phone 102.

Having adjusted their respective steering angles to offset the tilt angles in substantially parallel first planes, the two antenna arrays measure slightly different angles of incidence from the tracking tag 104 in planes that are substantially orthogonal to the first planes. As such, a locating engine (not shown) of the mobile phone 102 can determine the difference between these two angles (e.g., using PDoA) and, therefore, determine the angle of the tracking tag 104 with respect to the mobile phone 102. The mobile phone 102 can also perform a distance measurement (e.g., using RSS and/or TOA), which, in combination with the AoA, can yield the location of the tracking tag 104.

FIG. 2 illustrates an example system 200 including a mobile phone 202 (a tracking device) and a tracking tag 204 (a target device), wherein the system 200 scans antenna array steering angles to find the strongest receive signal strength from the tracking tag 204. The mobile phone 202 includes an antenna array (represented by an antenna 206 and an antenna 207) that is used to detect and locate the tracking tag 204, which transmits tracking signals (e.g., UWB signals) at regular intervals. In the described technology, two (e.g., substantially parallel) antenna arrays are used in combination to determine the AoA of the signals received from the tracking tag 204. Furthermore, the same (or other) antennas may be used in antenna arrays having different orientations (e.g., horizontal as opposed to vertical) to the antenna arrays shown to improve three-dimensional AoA detection.

In one implementation, the mobile phone 202 may be tilted with respect to a reference (e.g., the gravitational pull, transmission axis of the tracking tag signals). A tilt angle 205 indicates the angle of the mobile phone 202 with respect to the main lobe of the tracking tag 204. In contrast to the implementation described with respect to FIG. 1, FIG. 2 illustrates an implementation in which the main lobes of the antenna arrays are dynamically scanned or swept across a defined angular range in substantially parallel first planes to determine steering angles at which the strongest signals from the tracking tag 204 are detected. Accordingly, the antenna arrays scan across the defined angular range seeking the angle of strongest receive signal strength for each array, thereby offsetting the effect of the mobile device tilt without necessarily measuring the tilt angle.

In the implementation of the described technology in FIG. 2, rather than extending a beam pattern on a fixed axis, the antenna arrays scan a beam pattern across a wide angular range with respect to the mobile phone 102. A curved, double-headed arrow 220 in combination with the multiple ovals indicates the dynamic scanning action over time. Accordingly, phase shifters of the antenna arrays in the mobile phone 202 dynamically adjust the phases of antenna arrays so as to scan their main lobes to angles of strongest reception across a wide angular range.

As the scanning action of the antenna arrays of the mobile phone 202 sweeps the beam patterns back and forth within the scanning planes, the strongest signal strength from the tracking tag 204 is determined to be at the steering angles of the main lobe 212 of the beam pattern. The main lobe of the tracking tag transmissions is shown as solid oval 214 along an axis 215. The two antenna arrays measure slightly different angles of incidence from the tracking tag 204. As such, a locating engine (not shown) of the mobile phone 202 can determine the difference between these two angles and, therefore, determine the angle of the tracking tag 204 with respect to the mobile phone 202. The mobile phone 202 can also perform a distance measurement (e.g., using RSS and/or TOA), which, in combination with the AoA, can yield the location of the tracking tag 204.

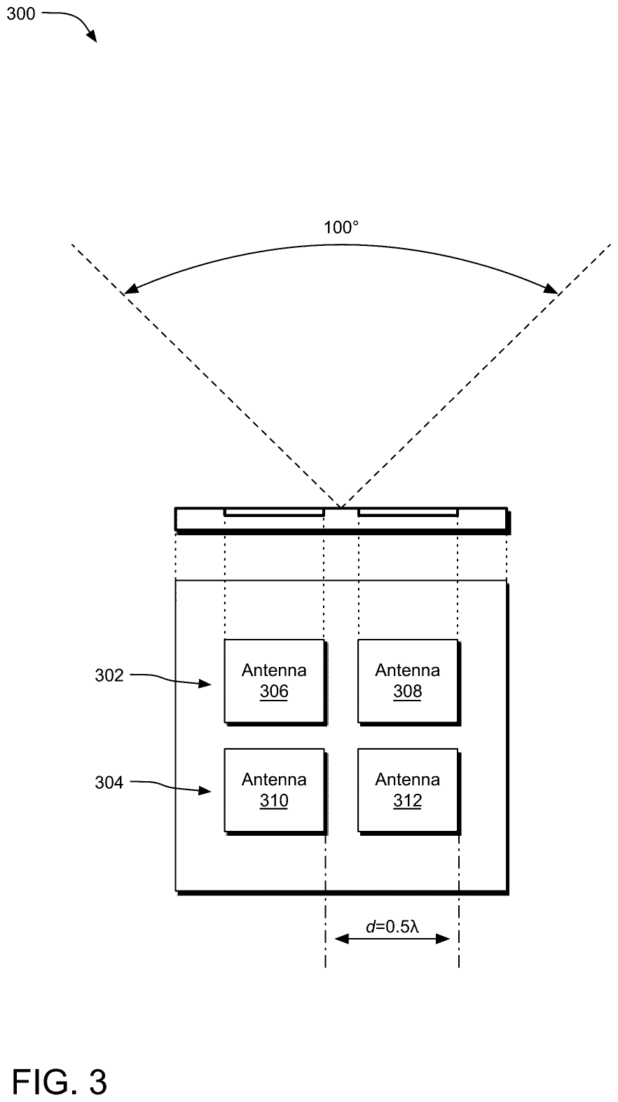

FIG. 3 illustrates an example antenna array 300 including a first antenna pair 302 (e.g., forming an antenna array) and a second antenna pair 304 (e.g., forming an antenna array) of a receiving device, both oriented to adjust steering angles in horizontal planes that are substantially parallel to each other. Each antenna pair represents a phased array capable of adjusting and/or scanning back and forth within a defined angular range. Each antenna in the antenna pairs (e.g., an antenna 306 and an antenna 308 in the first antenna pair 302 and an antenna 310 and an antenna 312 in the second antenna pair 304) is electrically connected as phased antenna arrays to a phase shifter circuitry capable of dynamically adjusting the phases (e.g., using time delays) of the antenna pair so that the beamforming on reception of an incoming radiofrequency beam is adjusted and/or scanned across a defined angular range.

The corresponding edges of antennas of an antenna pair are separated according to a distance d in the horizontal plane. In FIG. 3, the separation is indicated as d=0.5λ, where λ is the wavelength of the incoming radiofrequency beam. The illustrated antennas are shown in FIG. 3 as patch antennas, although other types of antennas may be employed.

The phase shifting circuitry can dynamically adjust the phase of each antenna in an antenna pair to adjust and/or scan across the defined angular range. In one implementation, a phase shift calculator sets the phase shift to offset a detected tilt angle. In another implementation, a phase shift calculator scans the main beams across the defined angular range to determine the phases at which the strongest strengths of the incoming radiofrequency beam are received by the antennas.

The phases for each phased antenna array, as determined by the phase shift calculator with respect to the incoming radiofrequency beam, can be processed by a phase difference of arrival calculator to determine a PDoA for an incoming radiofrequency signal. A target device locator circuit can use the PDoA to determine a vertical angle of arrival from the target device to the receiving device.

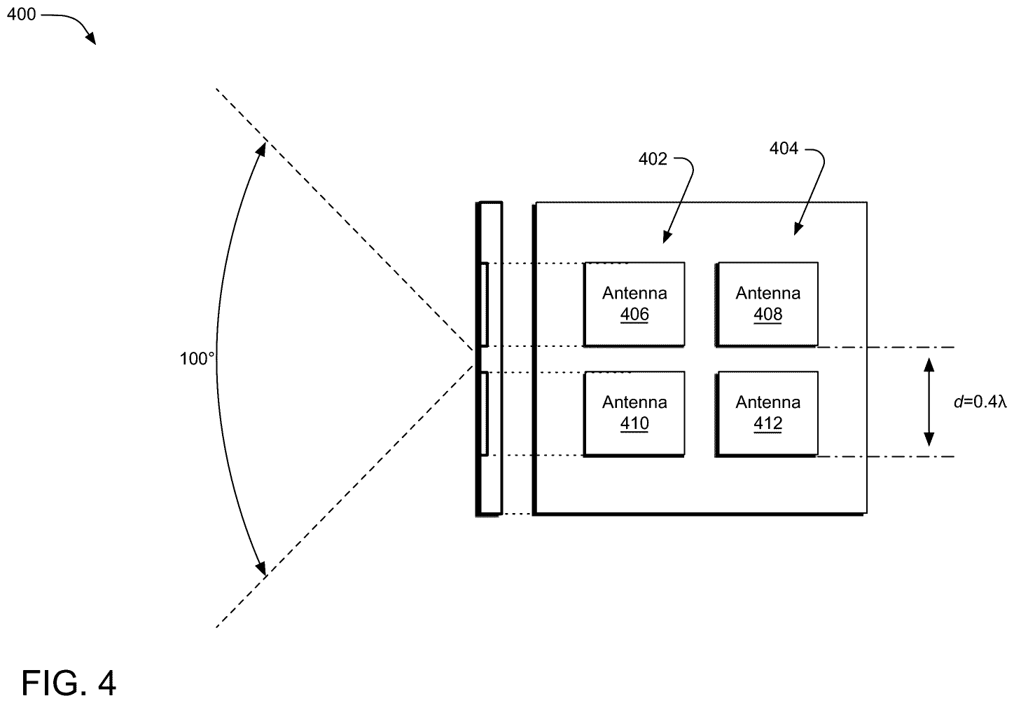

FIG. 4 illustrates an example antenna array 400 including a first antenna pair 402 (e.g., forming an antenna array) and a second antenna pair 404 (e.g., forming an antenna array) of a receiving device, both oriented to adjust and/or scan in vertical planes that are substantially parallel to each other. Each antenna pair represents a phased array capable of adjusting and/or scanning back and forth within a defined angular range. Each antenna in the antenna pairs (e.g., an antenna 406 and an antenna 410 in the first antenna pair 402 and an antenna 408 and an antenna 412 in the second antenna pair 404) is electrically connected as phased antenna arrays to a phase shifter circuitry capable of dynamically adjusting the phases (e.g., using time delays) of the antenna pair so that the beamforming on reception of an incoming radiofrequency beam is adjusted and/or scanned across a defined angular range.

The corresponding edges of antennas of an antenna pair are separated according to a distance d in the vertical plane. In FIG. 4, the separation is indicated as d=0.4λ, where λ is the wavelength of the incoming radiofrequency beam. The illustrated antennas are shown in FIG. 4 as patch antennas, although other types of antennas may be employed.

The phase shifting circuitry can dynamically adjust the phase of each antenna in an antenna pair to adjust and/or scan across the defined angular range. In one implementation, a phase shift calculator sets the phase shift to offset a detected tilt angle. In another implementation, a phase shift calculator scans the main beams across the defined angular range to determine the phases at which the strongest strengths of the incoming radiofrequency beam are received by the antennas.

The phases for each phased antenna array, as determined by the phase shift calculator with respect to the incoming radiofrequency beam, can be processed by a phase difference of arrival calculator to determine a PDoA for an incoming radiofrequency signal. A target device locator circuit can use the PDoA to determine a horizontal angle of arrival from the target device to the receiving device.

Although FIG. 3 and FIG. 4 separately illustrate antenna pairs adjusting steering angles horizontally and vertically, respectively, other implementations of the described technology can combine the horizontal and vertical steering angle adjustment implementations. Furthermore, additional antenna pairs and plans may be employed in other implementations.

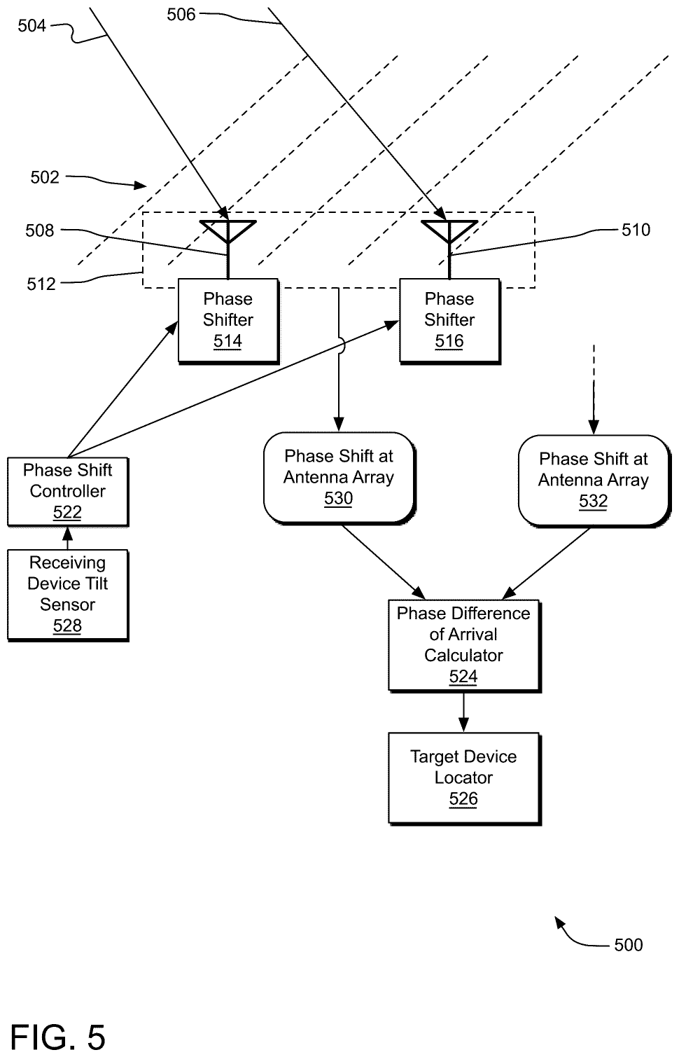

FIG. 5 illustrates example circuitry 500 for locating a target device (not shown). Wavefronts of an incoming radiofrequency signal are shown as parallel dashed lines 502, and individual incoming radiofrequency beams (beam 504 and beam 506) are shown as being received at slightly different angles by individual antennas (antenna 508 and antenna 510) of an antenna pair in an antenna array 512. Generally, the beams correspond to the steered main lobes of each antenna. In various implementations, at least two antenna arrays are employed to compute the PDoA of the received beams.

Each antenna of an antenna array is electrically coupled to phase shifter circuitry (e.g., phase shifter 514 and phase shifter 516). The phase shifter circuitry is capable of adjusting the phase of each antenna to adjust the beam steering in a plane across a defined angular range. The two antenna arrays typically scan in substantially parallel planes to each other. A receiving device tilt sensor 528 determines a tilt angle with respect to a reference (e.g., gravitational pull, a target device). A phase shift controller 522 determines the phase at which the steering angle can be adjusted to account for and/or offset any tilt of the tracking device and/or the antenna array with respect to the reference) as detected by accelerometers, compass components, and/or other sensors (collectively referred to as receiving device tilt sensor 528). The phase shift controller 522 adjusts the phase of control signals supplied to the phase shifter circuitry to adjust the steering angle of the antenna arrays.

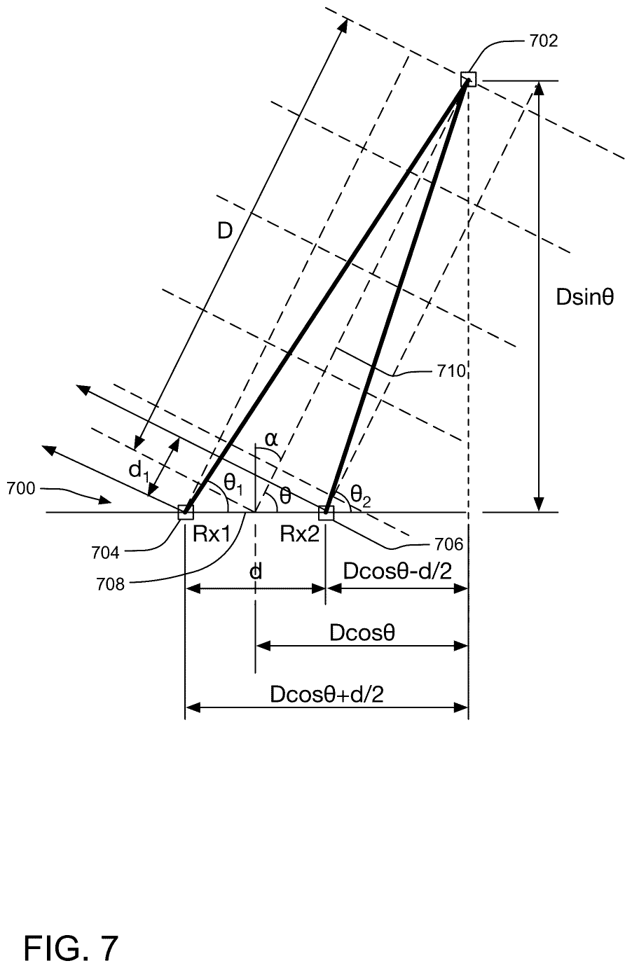

Responsive to the antennas of the antenna array 512 (and a counterpart antenna array) being set to account for the tilt, the phase shifts of the received beams detected by each antenna array (see phase shift at antenna array 530 from antenna array 512 and phase shift at antenna array 532 from the second (counterpart) antenna array) are passed to a phase difference of arrival calculator 524. The phase difference of arrival calculator 524 computes the phase difference of arrival (PDoA) between the phase shifts of the two antenna arrays. Typically, the substantially parallel planes of the beam steering adjustments are substantially orthogonal to the plane in which phase shifts and the AoA are determined (see FIG. 7 for phase shift descriptions). For example, a pair of antenna arrays that adjust the steering angles in horizontal planes are used to determine the AoA in a vertical plane and vice versa.

A target device locator 526 uses the PDoA between these two antenna arrays to determine the angle of arrival (AoA) of the incoming radiofrequency signal in a plane substantially orthogonal to the scan plane of the antenna pair of the antenna 508 and the antenna 510. The tracking device can also perform a distance measurement (e.g., using RSS and/or TOA), which, in combination with the AoA, can yield the location of the target device.

Other arrays may employ different pairings of antennas, such as antenna arrays that adjust the steering angle in differently oriented planes than the planes of the antenna arrays described with respect to FIG. 5 (e.g., orthogonal to those planes). These different pairings of antennas may employ the same antennas as the ones used in the first antenna pair and its companion antenna pair or different combinations of antennas.

In summary, some implementations of the circuitry 500 of FIG. 5 detect/measure the tilt of a tracking device, adjust the steering angle of the main lobes of at least two antenna arrays (in two substantially parallel planes) to offset this detected tilt, and then determine the PDoA of the beams received from the target device by the at least two antenna arrays in a plane that is substantially orthogonal to the two substantially parallel planes. The circuitry 500 can then compute the AoA from the PDoA to determine the angle of incidence from the target device to the tracking device.

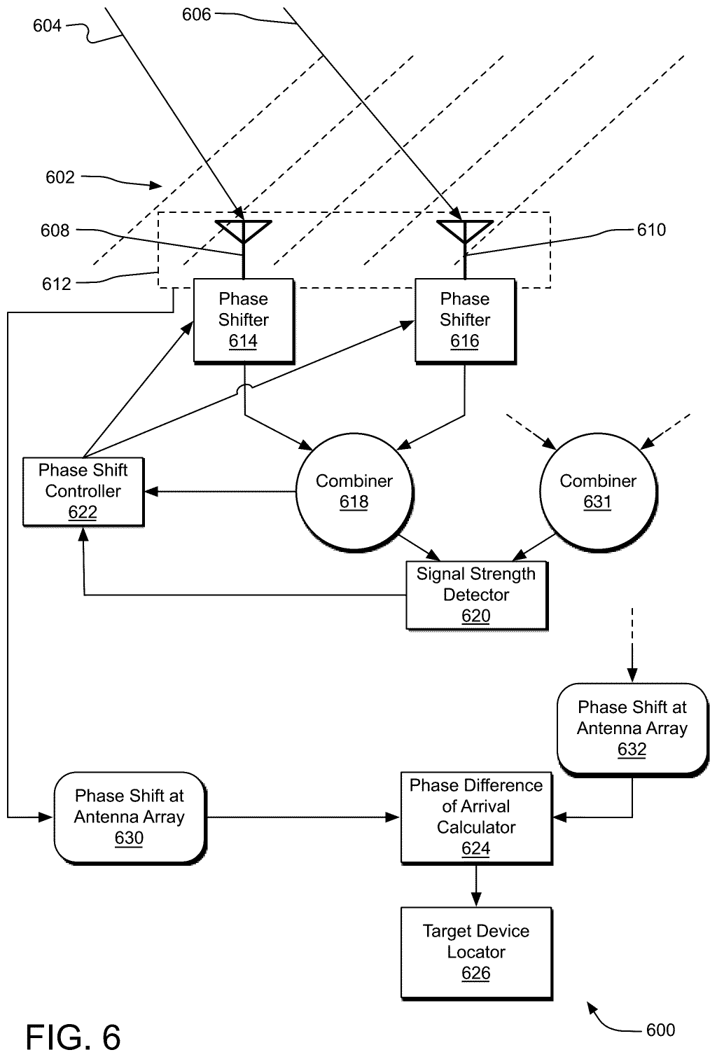

FIG. 6 illustrates example circuitry 600 for locating a target device (not shown). Wavefronts of an incoming radiofrequency signal are shown as parallel dashed lines 602, and individual incoming radiofrequency beams (beam 604 and beam 606) are shown as being received at slightly different angles by individual antennas (antenna 608 and antenna 610) of an antenna pair in an antenna array 612. Generally, the beams correspond to the steered main lobes of each antenna. In various implementations, at least two antenna arrays are employed to compute the PDoA of the received beams.

Each antenna of an antenna array is electrically coupled to phase shifter circuitry (e.g., phase shifter 614 and phase shifter 616). The phase shifter circuitry is capable of adjusting the phase of each antenna to scan the beam steering in a plane across a defined angular range. The phase shifting circuitry feeds the received signal into a combiner circuit 618, which combines the components of the received signal. Another combiner 631 receives received signals from the second (counterpart) antenna array. The two antenna arrays typically scan in substantially parallel planes to each other.

A signal strength seeker 620 evaluates the strength of the signals received by each antenna. A phase shift controller 622 determines the phases at which the strongest signal strength is detected by each antenna array, which are substantially analogous to the steering angle that offsets the tilt with respect to FIG. 5. The phase shift controller 622 adjusts the phase of control signals supplied to the phase shifter circuitry to adjust the steering angle of the antenna arrays.

Responsive to the antenna array 612 (and a counterpart antenna array) being set to direct steering angles of the strongest received signals, the phase shifts of the beams detected by each antenna array (see phase shift at antenna array 630 from antenna array 612 and phase shift at antenna array 632 from the second (counterpart) antenna array) are passed to a phase difference of arrival calculator 624. The phase difference of arrival calculator 624 computes the phase difference of arrival (PDoA) between the phase shifts of the two antenna arrays. Typically, the substantially parallel planes of the beam steering adjustments are substantially orthogonal to the plane in which phase shifts and the AoA are determined (see FIG. 7 for phase shift descriptions). For example, a pair of antenna arrays that adjust the steering angles in horizontal planes are used to determine the AoA in a vertical plane and vice versa.

A target device locator 626 uses the PDoA between these two antenna arrays to determine the angle of arrival (AoA) of the incoming radiofrequency signal in a plane substantially orthogonal to the scan plane of the antenna pair of the antenna 508 and the antenna 510. The tracking device can also perform a distance measurement (e.g., using RSS and/or TOA), which, in combination with the AoA, can yield the location of the target device.

Other arrays may employ different pairings of antennas, such as antenna arrays that adjust the steering angle in differently oriented planes than the planes of the antenna arrays described with respect to FIG. 5 (e.g., orthogonal to those planes). These different pairings of antennas may employ the same antennas as the ones used in the first antenna pair and its companion antenna pair or different combinations of antennas.

In summary, some implementations of the circuitry 600 of FIG. 6 can omit the direct detection/measurement of the tilt of a tracking device by scanning to determine the steering angles at which the received beams from the target device are received. Thereafter, the circuitry 600 sets the steering angles of at least two antenna arrays (in two substantially parallel planes), which essentially offsets tracking device tilt, and then determines the PDoA of the beams received from the target device by the at least two antenna arrays in a plane that is substantially orthogonal to the two substantially parallel planes. The circuitry 600 can then compute the AoA from the PDoA to determine the angle of incidence from the target device to the tracking device.

FIG. 7 illustrates example geometric parameters for a receiver device's antenna array 700 useful in locating a target device 702. The target device 702 transmits a radiofrequency signal (e.g., a UWB signal) to enable tracking devices to locate it within a two or three dimensional environment. The description of FIG. 7 also provides the foundation for computing PDoAs and AoAs using the scanning receiver antenna array 700, which includes an antenna array 704 (Rx1) and an antenna array 706 (Rx2).

The phase difference of arrival, in the described technology, measures the phase difference of the radiofrequency signal received at a tracking device based on phase shifts corresponding to two scanning receiver antenna arrays of the tracking device. As shown with regard to FIG. 3, for example, the two arrays scan in substantially parallel planes across a defined angular range and the phase difference between the phases at which the received strength of the radiofrequency signal at each of these arrays can be used to determine the angle of arrival of the radiofrequency signal with respect to a plane that is substantially orthogonal to the substantially parallel scanning planes.

The receivers are separated by a distance d along a base line 708 between the receivers. When considering a signal path between the target device 702 and an antenna array of a tracking device, the additional distance a wavefront travels to reach Rx1 (as compared to reaching Rx2 in the illustration, can be represented as d₁=d cos θ and the time the signal takes to traverse this additional distance d₁ can be represented as t₁=d cos θ/c, where d is the distance separating the receiving antenna arrays, c is the speed of light, and θ is the angle between the base line 708 connecting the two receivers and a target line 710 extending from the center of the base line and connecting to the target device 702. Other parameters include:
θ₁—a beam angle at receiver Rx1 from the target device
θ₂—a beam angle at receiver Rx2 from the target device
D—the distance between the center of the scanning receiver antenna array 700 and the target device 702
θₜ—tilt angle of the antenna array in the tracking device with respect to a reference
α—an angle of arrival parameter (α=90−θ)
λ—the wavelength of the incoming radiofrequency signal (e.g., the center wavelength of the signal's frequency bandwidth)

A phase shift calculator determines the progressive phase shift needed to accommodate for any tilt of the antenna array with respect to the base angle. A phase difference between two periodic signals with the same frequency can be calculated by time difference. Progressive phase shift (PPS), indicated by Δϕ, utilizes delay accumulation to quantify the time difference. For example, if the mobile device (e.g., and therefore the antenna array) is tilted away from the base angle, then the phase shift to account for this tilt can be determined by:

$$Progressive Phase {Shift}_{Tilt} = Δϕ = \frac{360 ° \times d \times sin ( Tilt Angle )}{λ}$$

Given d=0.5λ and Tilt Angle=75°, then the progressive phase shift to account for the tilt for each antenna array is given as:

$$Δϕ = 360 ° \times 0.5 \times sin ( 75 ° ) ≅ 173.8 °$$

Accordingly, applying a combination of the amplitude and the phase shift to two antenna arrays (1 and 2) may be represented as:

$$Progressive Phase {Shift}_{1} = ( 1 ∠0° + 1 ∠173 \text{.8} ° ) \\ Progressive Phase {Shift}_{2} = ( 1 ∠0° + 1 ∠173 \text{.8} ° )$$

In addition to the distance equation given above, the additional distance (d₁) a wavefront travels to reach a second antenna as compared to a first antenna in an antenna pair can be represented as:

$${d}_{1} = Δφ \frac{λ}{360 °} ,$$

which allows PDoA to be rewritten as:

$$PDoA = Δφ = \frac{360 °}{λ} d cos θ = \frac{360 °}{λ} d sin α$$

Given the PDoA of the two antenna pairs, the angle of arrival (AoA) can be calculated by:

$$AoA = α = a sin ( \frac{λ \times PDoA}{360 \times d} )$$

The AoA can be determined in different planes by using different sets of antenna pairs (e.g., horizontal or vertical).

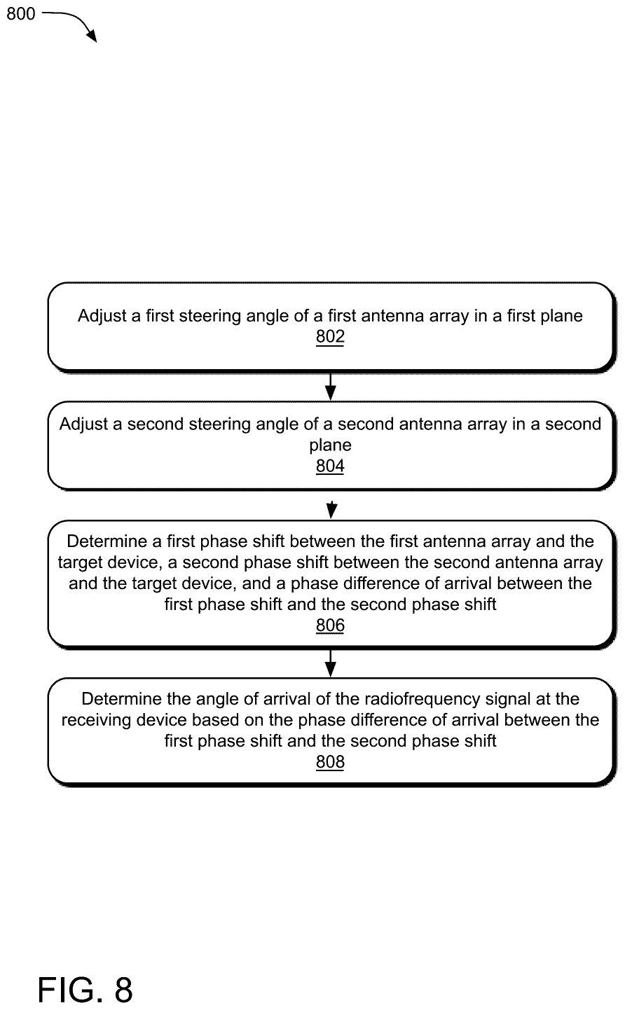

FIG. 8 illustrates example operations 800 for determining an angle of arrival of a radiofrequency signal received at a receiving device and transmitted by a target device. An adjusting operation 802 adjusts a first steering angle of a first antenna array in a first plane. Another adjusting operation 804 adjusts a second steering angle of a second antenna array in a second plane. In some implementations, the second plane is substantially parallel to the first plane.

In some implementations, the first and second steering angles offset a tilt angle of the receiving device as detected by a tilt sensor. In other implementations, the first and second steering angles are determined by dynamically scanning the first steering angle of the first antenna array to maximize signal strength of a first beam of the radiofrequency signal and the second steering angle of the second antenna array to maximize signal strength of a second beam of the radiofrequency signal.

A calculating operation 806 determines a first phase shift between the first antenna array and the target device, a second phase shift between the second antenna array and the target device, and a phase difference of arrival between the first phase shift and the second phase shift. Another calculation operation 808 determines the angle of arrival of the radiofrequency signal at the receiving device based on the phase difference of arrival between the first phase shift and the second phase shift. In some implementations, the angle of arrival is determined in a third plane substantially orthogonal to the first plane and the second plane.

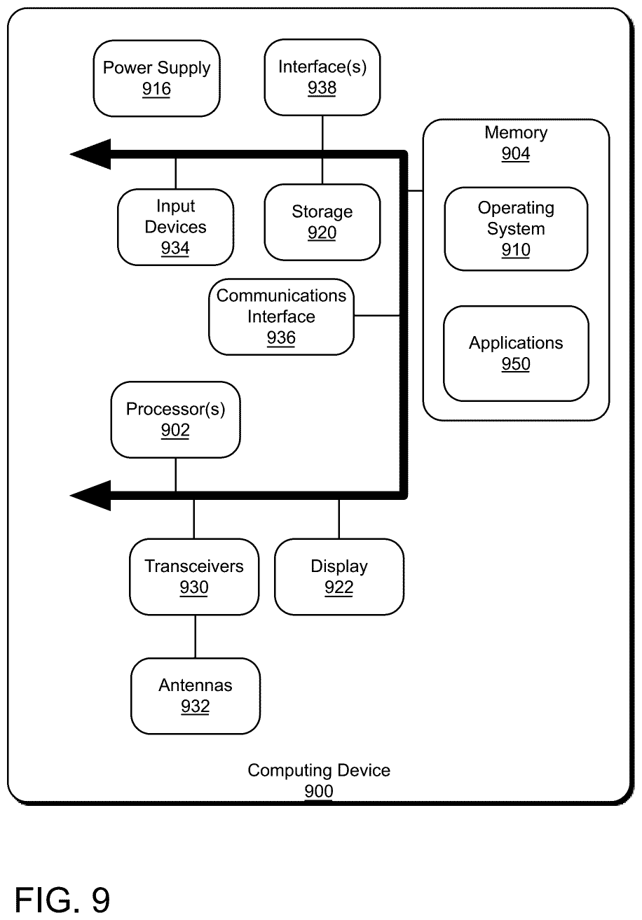

FIG. 9 illustrates an example computing device 900 for use in implementing the described technology. Although the described technology can typically be implemented in circuitry, some components of the described technology may be implemented in software, in combination with a hardware processor or other circuitry. The computing device 900 may be a client computing device (such as a laptop computer, a desktop computer, or a tablet computer), a server/cloud computing device, an Internet-of-Things (IoT), any other type of computing device, or a combination of these options. The computing device 900 includes one or more hardware processor(s) 902 and a memory 904. The memory 904 generally includes both volatile memory (e.g., RAM) and nonvolatile memory (e.g., flash memory), although one or the other type of memory may be omitted. An operating system 910 resides in the memory 904 and is executed by the processor(s) 902. In some implementations, the computing device 900 includes and/or is communicatively coupled to storage 920.

In the example computing device 900, as shown in FIG. 9, one or more modules or segments, such as applications 950, a phase shifter, a phase shift controller, a phase difference of arrival calculator, a target device locator, and other program code and modules are loaded into the operating system 910 on the memory 904 and/or the storage 920 and executed by the processor(s) 902. The storage 920 may store phases, angles, signal strengths, PDoA values, AoA values, and other data and be local to the computing device 900 or may be remote and communicatively connected to the computing device 900. In particular, in one implementation, components of a system for determining an angle of arrival of a radiofrequency beam received at the receiving device and transmitted by a target device may be implemented entirely in hardware or in a combination of hardware circuitry and software.

The computing device 900 includes a power supply 916, which may include or be connected to one or more batteries or other power sources, and which provides power to other components of the computing device 900. The power supply 916 may also be connected to an external power source that overrides or recharges the built-in batteries or other power sources.

The computing device 900 may include one or more communication transceivers 930, which may be connected to one or more antenna(s) 932 to provide network connectivity (e.g., mobile phone network, Wi-Fi®, Bluetooth®) to one or more other servers, client devices, IoT devices, and other computing and communications devices. The computing device 900 may further include a communications interface 936 (such as a network adapter or an I/O port, which are types of communication devices). The computing device 900 may use the adapter and any other types of communication devices for establishing connections over a wide-area network (WAN) or local-area network (LAN). It should be appreciated that the network connections shown are exemplary and that other communications devices and means for establishing a communications link between the computing device 900 and other devices may be used.

The computing device 900 may include one or more input devices 934 such that a user may enter commands and information (e.g., a keyboard, trackpad, or mouse). These and other input devices may be coupled to the server by one or more interfaces 938, such as a serial port interface, parallel port, or universal serial bus (USB). The computing device 900 may further include a display 922, such as a touchscreen display.

The computing device 900 may include a variety of tangible processor-readable storage media and intangible processor-readable communication signals. Tangible processor-readable storage can be embodied by any available media that can be accessed by the computing device 900 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 900. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A receiving device for determining an angle of arrival of a radiofrequency signal received at the receiving device and transmitted by a target device, the receiving device comprising: a first antenna array configured to adjust a first steering angle of the first antenna array in a first plane; a second antenna array configured to adjust a second steering angle of the second antenna array in a second plane; a phase difference of arrival calculator communicatively coupled to the first antenna array and the second antenna array and configured to determine a first phase shift between the first antenna array and the target device, a second phase shift between the second antenna array and the target device, and a phase difference of arrival between the first phase shift and the second phase shift; and a target device tracking circuit electrically coupled to the phase difference of arrival calculator and configured to determine the angle of arrival of the radiofrequency signal at the receiving device based on the phase difference of arrival between the first phase shift and the second phase shift.

Clause 2. The receiving device of clause 1, further comprising: a tilt sensor configured to detect a tilt angle of the receiving device with respect to a reference; and phase shifter circuitry configured to adjust the first steering angle to offset the tilt angle detected by the tilt sensor and to adjust the second steering angle to offset the tilt angle detected by the tilt sensor.

Clause 3. The receiving device of clause 1, further comprising: phase shifter circuitry configured to adjust the first steering angle by adjusting a phase of a control signal supplied to at least one antenna of the first antenna array and to adjust the second steering angle by adjusting a phase of a control signal supplied to at least one antenna of the second antenna array.

Clause 4. The receiving device of clause 1, wherein the second plane is substantially parallel to the first plane.

Clause 5. The receiving device of clause 1, wherein the angle of arrival is determined in a third plane substantially orthogonal to the first plane and the second plane.

Clause 6. The receiving device of clause 1, wherein the first antenna array includes at least a first antenna and a second antenna aligned in the first plane, and the second antenna array includes at least a third antenna and a fourth antenna aligned in the second plane.

Clause 7. The receiving device of clause 1, further comprising: phase shifter circuitry configured to dynamically scan the first steering angle of the first antenna array to maximize signal strength of a first beam of the radiofrequency signal and the second steering angle of the second antenna array to maximize signal strength a second beam of the radiofrequency signal.

Clause 8. A method of determining an angle of arrival of a radiofrequency signal received at a receiving device and transmitted by a target device, the method comprising: adjusting a first steering angle of a first antenna array in a first plane; adjusting a second steering angle of a second antenna array in a second plane; determining a first phase shift between the first antenna array and the target device, a second phase shift between the second antenna array and the target device, and a phase difference of arrival between the first phase shift and the second phase shift; and determining the angle of arrival of the radiofrequency signal at the receiving device based on the phase difference of arrival between the first phase shift and the second phase shift.

Clause 9. The method of clause 8, further comprising: detecting a tilt angle of the receiving device with respect to a reference using a tilt sensor; and adjusting the first steering angle to offset the tilt angle detected by the tilt sensor and to adjust the second steering angle to offset the tilt angle detected by the tilt sensor.

Clause 10. The method of clause 8, further comprising: adjusting the first steering angle by adjusting a phase of a control signal supplied to at least one antenna of the first antenna array and to adjust the second steering angle by adjusting a phase of a control signal supplied to at least one antenna of the second antenna array.

Clause 11. The method of clause 8, wherein the second plane is substantially parallel to the first plane.

Clause 12. The method of clause 8, wherein the angle of arrival is determined in a third plane substantially orthogonal to the first plane and the second plane.

Clause 13. The method of clause 8, wherein the first antenna array includes at least a first antenna and a second antenna aligned in the first plane, and the second antenna array includes at least a third antenna and a fourth antenna aligned in the second plane.

Clause 14. The method of clause 8, further comprising: dynamically scanning the first steering angle of the first antenna array to maximize signal strength of a first beam of the radiofrequency signal and the second steering angle of the second antenna array to maximize signal strength a second beam of the radiofrequency signal.

Clause 15. A receiving device for determining an angle of arrival of a radiofrequency signal received at the receiving device and transmitted by a target device, the receiving device comprising: a first antenna array configured to adjust a first steering angle of the first antenna array in a first plane; a second antenna array configured to adjust a second steering angle of the second antenna array in a second plane; a phase difference of arrival calculator communicatively coupled to the first antenna array and the second antenna array and configured to determine a phase difference of arrival of beams of the radiofrequency signal received that the receiving device; and a target device tracking circuit electrically coupled to the phase difference of arrival calculator and configured to determine the angle of arrival of the radiofrequency signal at the receiving device based on the phase difference of arrival.

Clause 16. The receiving device of clause 15, further comprising: a tilt sensor configured to detect a tilt angle of the receiving device with respect to a reference; and phase shifter circuitry configured to adjust the first steering angle to offset the tilt angle detected by the tilt sensor and to adjust the second steering angle to offset the tilt angle detected by the tilt sensor.

Clause 17. The receiving device of clause 15, wherein the second plane is substantially parallel to the first plane.

Clause 18. The receiving device of clause 15, wherein the angle of arrival is determined in a third plane substantially orthogonal to the first plane and the second plane.

Clause 19. The receiving device of clause 15, wherein the first antenna array includes at least a first antenna and a second antenna aligned in the first plane, and the second antenna array includes at least a third antenna and a fourth antenna aligned in the second plane.

Clause 20. The receiving device of clause 15, further comprising: phase shifter circuitry configured to dynamically scan the first steering angle of the first antenna array to maximize signal strength of a first beam of the radiofrequency signal and the second steering angle of the second antenna array to maximize signal strength a second beam of the radiofrequency signal.

Clause 21. A system for determining an angle of arrival of a radiofrequency signal received at a receiving device and transmitted by a target device, the system comprising: means for adjusting a first steering angle of a first antenna array in a first plane; adjusting a second steering angle of a second antenna array in a second plane; means for determining a first phase shift between the first antenna array and the target device, a second phase shift between the second antenna array and the target device, and a phase difference of arrival between the first phase shift and the second phase shift; and means for determining the angle of arrival of the radiofrequency signal at the receiving device based on the phase difference of arrival between the first phase shift and the second phase shift.

Clause 22. The system of clause 21, further comprising: means for detecting a tilt angle of the receiving device with respect to a reference using a tilt sensor; and means for adjusting the first steering angle to offset the tilt angle detected by the tilt sensor and to adjust the second steering angle to offset the tilt angle detected by the tilt sensor.

Clause 23. The system of clause 21, further comprising: means for adjusting the first steering angle by adjusting a phase of a control signal supplied to at least one antenna of the first antenna array and to adjust the second steering angle by adjusting a phase of a control signal supplied to at least one antenna of the second antenna array.

Clause 24. The system of clause 21, wherein the second plane is substantially parallel to the first plane.

Clause 25. The system of clause 21, wherein the angle of arrival is determined in a third plane substantially orthogonal to the first plane and the second plane.

Clause 26. The system of clause 21, wherein the first antenna array includes at least a first antenna and a second antenna aligned in the first plane, and the second antenna array includes at least a third antenna and a fourth antenna aligned in the second plane.

Clause 27. The system of clause 21, further comprising: means for dynamically scanning the first steering angle of the first antenna array to maximize signal strength of a first beam of the radiofrequency signal and the second steering angle of the second antenna array to maximize signal strength a second beam of the radiofrequency signal.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A receiving device for determining an angle of arrival of a radiofrequency signal received at the receiving device and transmitted by a target device, the receiving device comprising:
a first antenna array configured to adjust a first steering angle of the first antenna array in a first plane;
a second antenna array configured to adjust a second steering angle of the second antenna array in a second plane;
a phase difference of arrival calculator communicatively coupled to the first antenna array and the second antenna array and configured to determine a first phase shift between the first antenna array and the target device, a second phase shift between the second antenna array and the target device, and a phase difference of arrival between the first phase shift and the second phase shift; and
a target device tracking circuit electrically coupled to the phase difference of arrival calculator and configured to determine the angle of arrival of the radiofrequency signal at the receiving device based on the phase difference of arrival between the first phase shift and the second phase shift.

2. The receiving device of claim 1, further comprising:
a tilt sensor configured to detect a tilt angle of the receiving device with respect to a reference; and
phase shifter circuitry configured to adjust the first steering angle to offset the tilt angle detected by the tilt sensor and to adjust the second steering angle to offset the tilt angle detected by the tilt sensor.

3. The receiving device of claim 1, further comprising:
phase shifter circuitry configured to adjust the first steering angle by adjusting a phase of a control signal supplied to at least one antenna of the first antenna array and to adjust the second steering angle by adjusting a phase of a control signal supplied to at least one antenna of the second antenna array.

4. The receiving device of claim 1, wherein the second plane is substantially parallel to the first plane.

5. The receiving device of claim 1, wherein the angle of arrival is determined in a third plane substantially orthogonal to the first plane and the second plane.

6. The receiving device of claim 1, wherein the first antenna array includes at least a first antenna and a second antenna aligned in the first plane, and the second antenna array includes at least a third antenna and a fourth antenna aligned in the second plane.

7. The receiving device of claim 1, further comprising:
phase shifter circuitry configured to dynamically scan the first steering angle of the first antenna array to maximize signal strength of a first beam of the radiofrequency signal and the second steering angle of the second antenna array to maximize signal strength a second beam of the radiofrequency signal.

8. A method of determining an angle of arrival of a radiofrequency signal received at a receiving device and transmitted by a target device, the method comprising:
adjusting a first steering angle of a first antenna array in a first plane;
adjusting a second steering angle of a second antenna array in a second plane;
determining a first phase shift between the first antenna array and the target device, a second phase shift between the second antenna array and the target device, and a phase difference of arrival between the first phase shift and the second phase shift; and
determining the angle of arrival of the radiofrequency signal at the receiving device based on the phase difference of arrival between the first phase shift and the second phase shift.

9. The method of claim 8, further comprising:
detecting a tilt angle of the receiving device with respect to a reference using a tilt sensor; and
adjusting the first steering angle to offset the tilt angle detected by the tilt sensor and to adjust the second steering angle to offset the tilt angle detected by the tilt sensor.

10. The method of claim 8, further comprising:
adjusting the first steering angle by adjusting a phase of a control signal supplied to at least one antenna of the first antenna array and to adjust the second steering angle by adjusting a phase of a control signal supplied to at least one antenna of the second antenna array.

11. The method of claim 8, wherein the second plane is substantially parallel to the first plane.

12. The method of claim 8, wherein the angle of arrival is determined in a third plane substantially orthogonal to the first plane and the second plane.

13. The method of claim 8, wherein the first antenna array includes at least a first antenna and a second antenna aligned in the first plane, and the second antenna array includes at least a third antenna and a fourth antenna aligned in the second plane.

14. The method of claim 8, further comprising:
dynamically scanning the first steering angle of the first antenna array to maximize signal strength of a first beam of the radiofrequency signal and the second steering angle of the second antenna array to maximize signal strength a second beam of the radiofrequency signal.

15. A receiving device for determining an angle of arrival of a radiofrequency signal received at the receiving device and transmitted by a target device, the receiving device comprising:
a first antenna array configured to adjust a first steering angle of the first antenna array in a first plane;
a second antenna array configured to adjust a second steering angle of the second antenna array in a second plane;
a phase difference of arrival calculator communicatively coupled to the first antenna array and the second antenna array and configured to determine a phase difference of arrival of beams of the radiofrequency signal received that the receiving device; and
a target device tracking circuit electrically coupled to the phase difference of arrival calculator and configured to determine the angle of arrival of the radiofrequency signal at the receiving device based on the phase difference of arrival.

16. The receiving device of claim 15, further comprising:
a tilt sensor configured to detect a tilt angle of the receiving device with respect to a reference; and
phase shifter circuitry configured to adjust the first steering angle to offset the tilt angle detected by the tilt sensor and to adjust the second steering angle to offset the tilt angle detected by the tilt sensor.

17. The receiving device of claim 15, wherein the second plane is substantially parallel to the first plane.

18. The receiving device of claim 15, wherein the angle of arrival is determined in a third plane substantially orthogonal to the first plane and the second plane.

19. The receiving device of claim 15, wherein the first antenna array includes at least a first antenna and a second antenna aligned in the first plane, and the second antenna array includes at least a third antenna and a fourth antenna aligned in the second plane.

20. The receiving device of claim 15, further comprising:
phase shifter circuitry configured to dynamically scan the first steering angle of the first antenna array to maximize signal strength of a first beam of the radiofrequency signal and the second steering angle of the second antenna array to maximize signal strength a second beam of the radiofrequency signal.
